(19) United States
(12) Patent Application Publication
(10) Pub. No.: US 2026/0330630 A1
(43) Pub. Date: Oct. 22, 2026

(54) SYSTEMS AND METHODS FOR DECODING OBJECT TAGS

(71) Applicant: Araceli Biosciences Inc., Tigard, OR (US)

(72) Inventor: Kevin Ferguson, Beaverton, OR (US)

(21) Appl. No.: 19/183,527

(22) Filed: Apr. 18, 2025

(51) Int. Cl. G06T 7/00; G06T 7/44

(52) U.S. Cl. CPC G06T 7/0012; G06T 7/44; G06T 2207/10024; G06T 2207/10056; G06T 2207/10064; G06T 2207/20224; G06T 2207/30024

(57) ABSTRACT

Methods and systems are provided herein for decoding optical object tags. In an example, a method includes obtaining multi-channel image data of a sample including a plurality of cells; extracting, for each cell of the plurality of cells and from the multi-channel image data, a respective sub-image including that cell; coloring each respective sub-image using a red-green (RG) or red-green-blue (RGB) model based on the multi-channel image data, such that each respective colored sub-image comprises a plurality of colored pixels; identifying a representative perceptual hue for each respective colored sub-image based on the plurality of colored pixels; and classifying the plurality of cells into two or more classes based on the representative perceptual hue for each respective colored sub-image.

### TECHNICAL FIELD

Embodiments of the subject matter disclosed herein relate generally to fluorescence microscopy, and more specifically to decoding object tags imaged with fluorescence microscopy.

### BACKGROUND AND SUMMARY

Fluorescence microscopy-based bioassays rely on incorporation of fluorophores (e.g., fluorescent dyes or tags) into cells in order to facilitate visualization of specific cellular structures, proteins, nucleic acids, and the like. A given fluorophore may be configured to emit light in a specified wavelength range, and a fluorescence microscopy imaging system may include multiple emission filters to allow visualization of emitted light in various discrete wavelength ranges (referred to as channels). Thus, different fluorophores may be imaged across different channels to create single-channel images (where only one type of fluorescent tag is visualized in each image) or multi-channel images (where multiple types of fluorescent tags are imaged and merged into one image together). Some imaging protocols, such as optical pooled screens, may dictate that fluorescent tags incorporated into cells be identified across cells and/or multiple rounds of imaging. However, some fluorescent tags may straddle multiple channels and thus may be visible in more than one channel. Further, noise, debris, and other issues may cause visualization of non-desired structures. These issues can confound the ability to detect and differentiate different fluorescent tags visualized in an image.

A method for automatically decoding fluorescent tags is herein provided that addresses the above issues. In one example, a method includes obtaining multi-channel image data of a sample including a plurality of cells; extracting, for each cell of the plurality of cells and from the multi-channel image data, a respective sub-image including that cell; coloring each respective sub-image using a red-green (RG) or red-green-blue (RGB) model based on the multi-channel image data, such that each respective colored sub-image comprises a plurality of colored pixels; identifying a representative perceptual hue for each respective colored sub-image based on the plurality of colored pixels; and classifying the plurality of cells into two or more classes based on the representative perceptual hue for each respective colored sub-image.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a diagram of a computing device;

FIG. 2A is an example multi-channel fluorescent image of a plurality of cells tagged with a plurality of optical tags;

FIG. 2B is an example plot of fluorophore emission spectra and imager emission filters;

FIG. 3 is a high level flowchart illustrating a method for identifying optical tags in image data of a sample including a plurality of cells to read barcode annotations;

FIG. 4 is a flowchart illustrating a method for decoding the optical tags in the image data;

FIG. 5 shows an example colored sub-image and a plot showing signal intensity of the sub-image in each of three channels;

FIG. 6 shows a first example of visual output of the decoding method of FIG. 5; and

FIG. 7 shows a second example of visual output of the decoding method of FIG. 5.

### DETAILED DESCRIPTION

The present description relates to decoding optical tags used in optical screens, such as high content analysis. The demand for evaluating ever more compounds, gene knockouts, and other perturbations for fundamental biological knowledge and new therapeutics discovery have led to the ability to identify cellular genotype via barcodes within each cell that can be read, typically as one code element per “round” of treatment and imaging. For example, for typical optical pooled screens (OPS), the barcode annotation is a sequence of fluorescently-labeled nucleotides (one color per nucleotide, or two colors multiplexed as four combinations of presence and absence to annotate each of four nucleotides). Each round results in a fluorescent spot within each cell, and successive rounds can be used to build (or “read”) sequences.

Thus, barcodes are implemented in high-content screening (HCS) systems by tagging objects, such as cells, with various fluorophores. Each fluorophore has different excitation and emission spectra, which are used to create a sequence of tags that form an object annotation, such as a cell barcode. These barcodes may be used for identifying perturbation classes, such as genotypes in OPS.

However, developing compatible fluorophore combinations can be challenging. Some fluorophores are not easily interchangeable due to their specific excitation and emission spectra, which may not align well with the emission filters of certain HCS imaging systems. For example, in an ideal scenario, each fluorophore would be visualized neatly in one channel (and only one channel) of the HCS imaging system. However, in reality, fluorophores are often visible in multiple channels and the ratio of what is visible in each channel for each fluorophore may not be known. This incompatibility complicates the barcode decoding process (e.g., where each cell is assigned a tag at each round of imaging).

Prior solutions utilized “unmixing,” a technique that uses matrix operations and linear algebra for a change of basis to separate overlapping spectral signals. Despite its theoretical effectiveness, unmixing faces several practical challenges. Often the relative signals for a given fluorophore that has emissions spread in two or more channels are not known, and therefore the unmixing matrix needs to be determined via matrix inversion or a mathematical equivalent. The specifics of the fluorophore emission mixing and image impairments often make the matrix inversion or equivalent untenable, resulting in mathematical singularity or very significant errors. In other words, the unmixing matrix often may not be determined.

Thus, according to embodiments disclosed herein, a ratio analysis may be applied per round of barcode reading to determine a multichannel color for each tagged object (e.g., cell). This process occurs after illumination vignette correction, ensuring color consistency across multiple channels. The solution calculates the average “color” of pixels above a threshold brightness from the relevant channels. Given that ground truth is typically established through visual inspection, the channels are mapped to RGB, with most of the signal concentrated in the red and green channels, where human color perception is most sensitive. The automated analysis uses these RGB values, converting them to respective (pseudo-) perceptual hues.

The hue values are then subjected to statistical analysis to separate the hue values into classes corresponding to the incorporated fluorophore, such as using k-cluster fitting (where k is the number of classes) if all classes have signal in the channels, or (k−1)-cluster fitting if one class is “black” (with the brightness threshold applied to the object color). Preprocessing steps may be implemented to eliminate saturated (clipped) channel pixels, which can introduce non-linear errors and shift the resulting color, rendering it invalid for classification. The nominal representation for perceptual color used may be CIE1939, which encompasses hue representation.

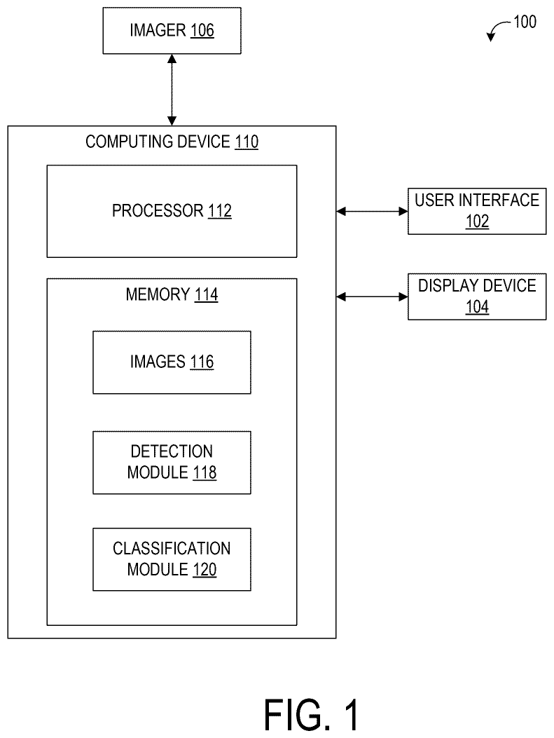

Turning now to the figures, FIG. 1 shows an exemplary computing system 100, according to an embodiment. The computing system 100 includes a computing device 110, which further includes a processor 112 and a memory 114. The processor 112 may comprise one or more computational components usable for executing machine-readable instructions. For example, the processor 112 may comprise a central processing unit (CPU) or may include, for example a graphics processing unit (GPU). The processor 112 may be positioned within the computing device 110 or may be communicatively coupled to the computing device 110 via a suitable remote connection.

The memory 114 may comprise one or more types of computer-readable media, including volatile and/or non-volatile memory. The volatile memory may comprise, for example, random-access memory (RAM), and the non-volatile memory may comprise read-only memory (ROM). The memory 114 may include one or more hard disk drive(s) (HDDs), solid state drives (SSDs), flash memory, and the like. The memory 114 is usable to store machine-readable instructions, which may be executed by the processor 112. The memory 114 is further configured to store images 116, which may comprise digital images captured or created using a variety of techniques, including digital imaging, digital illustration, and more.

At least a portion of the images 116 may be acquired via an imager 106. The imager 106 may be one or more of a microscope (e.g., a light microscope, a fluorescence microscope), a multi-well plate imager, and another type of bioassay imager, for example. The imager 106 may include one or more light sources, including broad and/or narrow spectrum light sources. Examples of broad spectrum light sources include light sources that emit light over a wide wavelength range, such as lamps (e.g., mercury lamps, halogen lamps) that emit light spanning the ultra-violet (UV) and visible ranges. Examples of narrow spectrum light sources include light sources that emit light from a narrow wavelength range or wavelength band, such as light-emitting diodes (LEDs) and lasers. The imager 106 may further include at least one image sensor, such as a charge-coupled device (CCD), an electron multiplying CCD (EMCCD), an active pixel sensor (e.g., a complementary metal-oxide-semiconductor, or CMOS, sensor), or another type of sensor that detects light in a location-specific manner, such as in an array-based fashion. Additionally, the imager 106 may include one or more optical coupling devices (e.g., lenses and mirrors), filters, beam splitters, and the like that may be used to direct light of a desired wavelength or wavelength range to a sample being imaged and receive light transmitted by, reflected by, or emitted by (e.g., depending on the imaging modality) the sample at the image sensor(s).

The memory 114 further includes a detection module 118, which comprises machine-readable instructions that may be executed by the processor 112 to identify objects in the images 116 and place bounding boxes on the objects. The detection module 118 may utilize suitable methods for identifying cells and placing bounding boxes, such as segmentation. In some examples the detection module 118 may utilize template matching to identify cells.

In some examples, the memory 114 may further include a classification module 120, which comprises machine-readable instructions that may be executed by the processor 112 to classify objects (e.g., cells) in the images 116 based on the emission spectra of each cell, as explained in more detail below. In some examples, the classification module 120 may be configured to read and aggregate barcode tags in order to generate a barcode annotation for each cell.

The computing system 100 further includes a user interface 102, which may comprise one or more peripherals and/or input devices, including, but not limited to, a keyboard, a mouse, a touchpad, or virtually any other input device technology that is communicatively coupled to the computing device 110. The user interface 102 may enable a user to interact with the computing device 110, such as to select one or more images to evaluate.

The computing system 100 further includes a display device 104, which may be configured to display outputs of the detection module 118 and/or the classification module 120, display the images themselves, and/or display other features/parameters. In some examples, the display device 104 may be a liquid crystal display (LCD), a light-emitting diode display (LED), or an organic light-emitting diode display (OLED). The user may select or otherwise input parameters (e.g., imaging protocols) via the user interface 102 based on options displayed via the display device 104.

In some examples, the computing device 110 may be implemented over a cloud or other computer network. For example, the computing device 110 is shown in FIG. 1 as constituting a single entity, but it is to be understood that the computing device 110 may be distributed across multiple devices, such as across multiple servers. Processors of the computing device may be single core or multicore, and the programs executed thereon may be configured for parallel or distributed processing. A logic subsystem of the computing device (e.g., memory) may optionally include individual components that are distributed throughout two or more devices, which may be remotely located and/or configured for coordinated processing. One or more aspects of the logic subsystem may be virtualized and executed by remotely accessible networked computing devices configured in a cloud-computing configuration. For example, the images 116 may be stored in the memory 114 of the computing device 110 and accessed by detection module 118 on a remote device. Output from the detection module on the remote device may be sent back to the computing device 110 for storage in the memory 114.

As used herein, the terms “system” or “module” may include a hardware and/or software system that operates to perform one or more functions. For example, a module or system may include a computer processor, controller, or other logic-based device that performs operations based on instructions stored on a tangible and non-transitory computer readable storage medium, such as a computer memory. Alternatively, a module or system may include a hard-wired device that performs operations based on hard-wired logic of the device. Various modules or systems shown in the attached figures may represent the hardware that operates based on software or hardwired instructions, the software that directs hardware to perform the operations, or a combination thereof. For example, the detection module 118 and/or the classification module 120 may be implemented using hardware, software, firmware, or a combination thereof. In some aspects, several portions of the subject matter described herein may be implemented via Application Specific Integrated Circuits (ASICs), Field Programmable Gate Arrays (FPGAs), semiconductor devices based around a matrix of configurable logic blocks (CLBs), connected via programmable interconnects. Some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as a combination thereof.

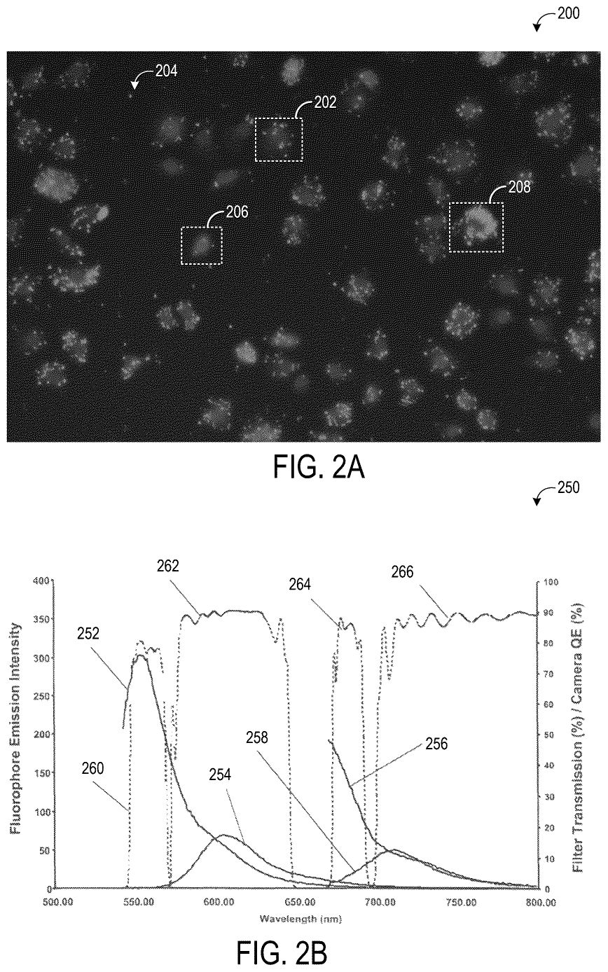

FIG. 2A shows an example field of view (FOV) image 200 of a sample including a plurality of tagged cells that may be obtained with a suitable imager, such as imager 106. FOV image 200 is a multi-channel fluorescent image, where fluorescent light is captured at three different wavelength ranges (e.g., channels) and then the images are merged together. The cells may be tagged with fluorescent tags, such as to facilitate barcode annotations. For example, the tags may include fluorescently-labeled nucleotides, where each cell incorporates one type of tagged nucleotide during a round of tagging. The four nucleotides are labeled with different fluorophores having different emission maxima and spectral range.

For example, FIG. 2B shows a plot 250 of fluorophore emission spectra and imager emission filters. The fluorophores that may be used in an example OPS include a first fluorophore having a first emission spectrum 252. In the example shown, the first fluorophore may be used to label the nucleotide G and may have an emission maximum of 560 nm. The fluorophores that may be used in the example OPS may further include a second fluorophore having a second emission spectrum 254. In the example shown, the second fluorophore may be used to label the nucleotide T and may have an emission maximum of 610 nm. The fluorophores may further include a third fluorophore having a third emission spectrum 256 and a fourth fluorophore having a fourth emission spectrum 258. In the example shown, the third fluorophore may be used to label the nucleotide A and may have an emission maximum of 675 nm and the fourth fluorophore may be used to label the nucleotide C and may have an emission maximum of 715 nm.

The plot 250 further shows emission filters that may be used to filter the emissions from the fluorophores (e.g., the light reaching the detector of the imager) to thereby create channels of the imager. The example shown in FIG. 2B includes four channels/emission filters, with the light transmitted by the filters shown by the dashed lines. A first channel 260 allows transmission of only light in a first wavelength range, herein 545-575 nm. A second channel 262 allows transmission of only light in a second wavelength range, herein 575-650 nm. A third channel 264 allows transmission of only light in a third wavelength range, herein 675-690 nm. A fourth channel 266 allows transmission of only light in a fourth wavelength range, herein 700 nm and above (e.g., at least to 800 nm).

To build a barcode annotation, the FOV image 200 may be processed to determine which nucleotide was incorporated into each cell based on the emission spectra of each cell, in a process referred to as decoding. Using the above example, cells that incorporate G should exhibit spots that are visible in the first channel, cells that incorporate T should exhibit spots that are visible in the second channel, etc. However, as appreciated by FIG. 2B, the first emission spectrum 252 has a relatively long range such that the first fluorophore is visible in both the first channel and the second channel, and is visible at approximately the same intensity as the second fluorophore in the second channel. Similarly, the third fluorophore is visible in both the third and fourth channels, with approximately the same intensity as the fourth fluorophore in the fourth channel.

As explained above, an image may be obtained in each channel, and in many cases, the first channel may be used to visualize cellular stain such as DAPI, leaving three channels (and hence three images) to visualize the fluorophores. For example, the first channel may be shifted to image a lower wavelength range to visualize DAPI, leaving only the second, third, and fourth channels for visualizing the fluorophores. The images generated from each channel may initially be grayscale images that depict intensity values. Each image may be pseudo-colored based on the wavelength range designated for that channel, e.g., an image for the second channel may be pseudo-colored in blue, an image for the third channel may be pseudo-colored in green, and an image for the fourth channel may be pseudo-colored in red. The three images may be merged, with pixels that exhibit intensity in more than one channel colored based on the combination of channels (e.g., resulting in yellow or cyan).

The manner in which multi-channel fluorescent images are generated, along with various other issues, may confound the process of decoding. For example, four nucleotides are labeled with four different fluorophores, but imaging only occurs in three channels. Further, some fluorophores may emit light across multiple channels, as explained above. Thus, the total emission spectra for each spot may be taken into account (e.g., the intensity of each pixel in each channel) and used in an unmixing process, as explained above, but the ratio of intensity across the channels may not be known for each fluorophore. Further, as appreciated from FIG. 2A, some cells may exhibit spot heterogeneity where spots of two or more different colors are present, such as in first cell 202. Noise/debris may be present that may fluoresce and appear as random spots, such as in area 204. Some cells may exhibit few to no spots (e.g., empty cells), such as second cell 206. Additionally, as appreciated in second cell 206, interference from nuclear or cytosolic stains that help visualize the cells may occur. As in the case of third cell 208, pixel clipping may occur where some pixels exhibit saturation in one channel that can lead to color shifts. Other problems may also be present, such as excitation variation, illumination profile errors, and the like. Further still, ground truth data that indicates the actual incorporated fluorophores is lacking, other than human audits of the pseudo-colored image and class counts after decoding.

Thus, the approach disclosed herein addresses these issues by predicting human audits of pseudo-colored images using RGB mapping for greatest perceptual sensitivity to color changes and optional filtering.

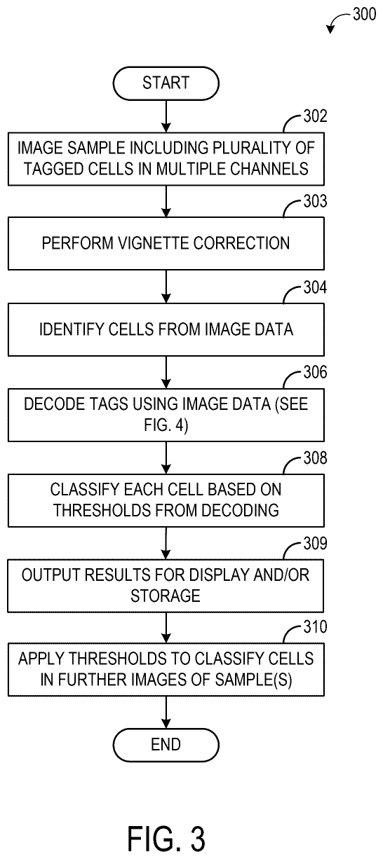

FIG. 3 illustrates a high-level method 300 for identifying tags for cell barcoding of a sample including a plurality of cells. Method 300 may be carried out by a computing device, such as the computing device 110 of FIG. 1 (e.g., by executing instructions stored in memory of the computing device). Method 300 may be executed in response to a request to perform an optical pooled screen on the sample. In some examples, the request may be a manual request initiated by a user (e.g., a user may select an image and enter a request to detect objects in the image and read the tags in the image by selecting a user interface element or menu option). In other examples, the request may be an automatic request initiated in response to execution of a particular imaging protocol. For example, a user may select an imaging protocol from among a plurality of stored imaging protocols. The selected imaging protocol may dictate that object detection, tag reading, and tag aggregation be performed on all or on selected images obtained while executing the imaging protocol.

At 302, method 300 includes imaging the sample in multiple channels, wherein the sample includes a plurality of tagged cells. The plurality of cells may have been previously subject to perturbations, such as gene knockouts or gene mutations, and may include DNA or RNA encoding barcode annotations that may be specific to each type of perturbation (e.g., used to identify the particular perturbation made to a given cell). The plurality of cells may have undergone a round of tagging, where the cells are tagged with fluorescently-labeled nucleotides or other tags (e.g., protein-based tags). In an example, each type of nucleotide may be tagged with a different type of fluorophore having different emission spectra, such as the nucleotide G labeled with a first fluorophore, the nucleotide T labeled with a second fluorophore, etc., as explained above. In this way, during a round of tagging, a first subset of cells of the plurality of cells may incorporate the first fluorophore, a second subset of cells of the plurality of cells may incorporate the second fluorophore, a third subset of cells of the plurality of cells may incorporate the third fluorophore, and a fourth subset of cells of the plurality of cells may incorporate the fourth fluorophore. The sample may be imaged with an imager, such as imager 106 of FIG. 1. Image data may be acquired at each of a plurality channels. For example, first image data may be acquired of the sample with a first channel (e.g., capturing only light of a first wavelength range), second image data may be acquired of the sample with a second channel (e.g., capturing only light of a second wavelength range), and third image data may be acquired of the sample with a third channel (e.g., capturing only light of a third wavelength range). In some examples, depending on the imager, fourth image data may be acquired of the sample with a fourth channel (e.g., capturing only light of a fourth wavelength range) and/or fifth image data may be acquired of the sample under brightfield illumination. Each set of image data may include an intensity value for each pixel of a detector of the imager. It is to be appreciated that the sample is not moved between acquisitions of the various sets of image data and thus image registration is not needed to align the various sets of image data.

At 303, vignette correction is performed on the image data. Vignette comprises variance in illumination across a field of view, such that some areas of an image have higher illumination than others, owing to characteristics of the imaging system (e.g., the imager 106). Typically, the illumination profile of the imaging system (microscopy illumination pattern across the image, typically approximately 2-D Gaussian) is characterized by imaging a flat field. The illumination profile of the imaging system may be presented as images representing the variation of illumination over the captured images of the flat field. Vignette correction is performed by taking the inverse and applying normalization, for example the maximum point of the flat field image may be used as a reference pixel scaled to 1.0 in the correction image. This correction image is then pixel-wise multiplied by all images that used that illumination of the imaging system.

At 304, each cell of the plurality of cells is identified from the image data. In some examples, each cell may be identified from the fifth image data, which may be used to form a brightfield image. In other examples, each cell may be identified from the first image data, which may be used to form a first image that depicts a particular cellular dye, such as DAPI. Each cell may be located via segmentation or another suitable method on the first image or the brightfield image. As a non-limiting example, template matching with a reference image may be performed on the brightfield image to locate a cell structure (e.g., nucleus) of each cell. In either example, bounding boxes may be placed (and stored in memory) that demarcate the location of each cell in the image data space.

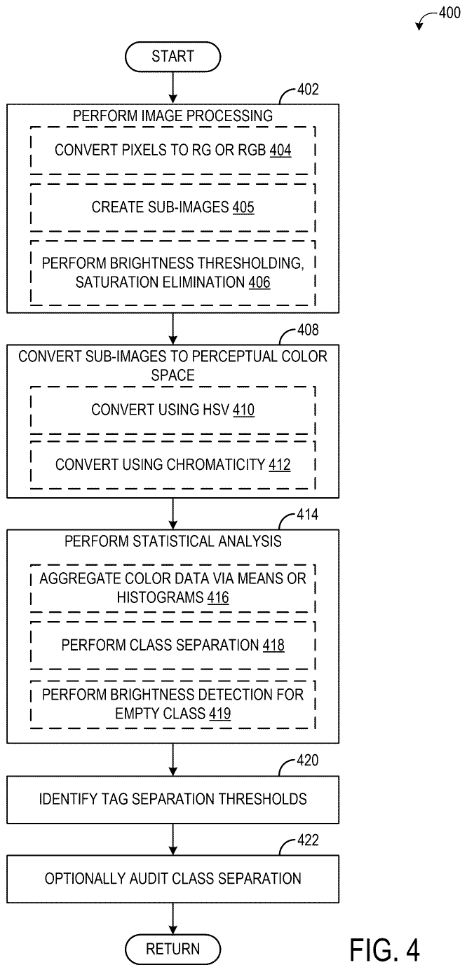

At 306, method 300 includes decoding the tags using the image data, which is explained in more detail below with respect to FIG. 4. Briefly, decoding the tags may be a process that is applied to identify the tag/fluorophore (and hence nucleotide) incorporated into each cell, in order to build the barcodes for each cell. The decoding process includes coloring each pixel (using either the red-green (RG) color model or the red-green-blue (RGB) color model) based on the image data for each channel. Each cell may be assigned a perceptual color based on the RG or RGB color for each pixel of that cell. For example, a hue for each cell may be determined based on an average of the colored pixels for that cell (as defined by the pixels within the bounding box demarcating that cell), with pre-processing performed to apply brightness thresholding (e.g., to remove background noise), remove/correct saturation (e.g., to reduce color shifts owing to saturated pixels), and/or apply vignette correction (e.g., to ensure that colors remain consistent across multiple channels). The perceptual color values are subject to statistical analysis such as clustering (e.g., k-means clustering) to identify thresholds that separate the cells into classes (by hue), which correspond to the different fluorophores. Thus, the output or end result of the decoding process is a plurality of threshold values (e.g., three) that can be applied to assign each cell a tag based on that cell's perceptual color.

Thus, at 308, method 300 includes classifying each cell based on the thresholds determined from the decoding and the perceptual color assigned to each cell during the decoding. The cells may be classified into a plurality of classes, with each class corresponding to a tag/fluorophore. For example, all cells with a hue value equal to or below a first threshold may be classified as exhibiting a first fluorophore and hence include a first nucleotide, all cells with a hue value above the first threshold and equal to or below a second threshold may be classified as exhibiting a second fluorophore and hence include a second nucleotide, etc. Once a cell is classified into a class associated with a tag, an indication of the tag is stored in memory and associated with that cell (e.g., via bounding box location) as a first tag of the barcode annotation for that cell. Thus, at 309, method 300 includes outputting the results of the decoding/classification for display and/or storage in memory. For example, as explained above, a barcode annotation for each cell may be built based on the fluorophore/tag identified for each cell, and the barcode annotation for each cell may be stored in memory and optionally displayed on a display device. Further, as will be explained in more detail below, in some examples a colored FOV image of the plurality of cells may be displayed with bounding boxes overlaid on the colored FOV image that identify each cell and the tag/class that each cell was classified into.

It is to be appreciated that the process of building a barcode annotation for each cell involves creating a sequence or code that represents a genetic or molecular signature of that cell based on the fluorophore classifications. For each round of tagging and imaging, the cell is assigned a nucleotide based on which fluorophore class it was assigned to during classification. For example, if a cell is classified into a class corresponding to the first fluorophore which is associated with nucleotide G, then G becomes part of that cell's barcode annotation. Through multiple rounds of tagging, imaging, and classification, a sequence of nucleotides is built up for each cell, forming the complete barcode annotation. This barcode annotation can then be used to identify specific genetic modifications or perturbations that were made to that cell.

At 310, the threshold hue values determined from the decoding may be applied to classify cells in further images of the sample and/or further images of further samples. For example, once a tag has been identified for each cell of the plurality of cells, a second round of tagging may be performed where the initial tags are quenched and each cell is again tagged such that a fluorescently-labeled nucleotide is incorporated by each cell according to each cell's barcode annotation. The plurality of cells may again be imaged in multiple channels, as explained above, and each cell identified in the image data (and registered to the location of that cell in the initial image data). The pixels of each cell may be colored, as done in the decoding process, and a hue value assigned to each cell based on the average of the colored pixels for that cell. The cells may be classified, and thus assigned a tag, based on the hue value relative to the thresholds defined in the decoding. If the same fluorophores are used, the thresholds from the decoding may be used to assign tags to other samples of tagged cells. Method 300 then ends.

FIG. 4 illustrates a method 400 for decoding fluorophore-based tags incorporated into a plurality of cells. Method 400 may be carried out by a computing device, such as the computing device 110 of FIG. 1. In some examples, method 400 may be carried out as part of method 300 of FIG. 3, such as at 306 of method 300.

At 402, method 400 includes performing image processing on the image data of the sample (e.g., the image data collected at 302 of method 300). As explained above, the image data may include image data in multiple channels. In some examples, the image data may include image data in two channels, such as the second image data and the third image data described above. In other examples, the image data may include image data in three channels, such as the second image data, the third image data, and the fourth image data described above.

Performing the image processing may include, as indicated at 404, converting each pixel to an RG or RGB color, based on the image data, to form a colored field of view (FOV) image. In examples where the image data is in two channels, each pixel may be converted to an RG color. For example, based on the second image data, each pixel may be assigned a red color that corresponds to the intensity value for that pixel in the second image data, and based on the third image data, each pixel may be assigned a green color that corresponds to the intensity value for that pixel in the third image data. In examples where the image data is in three channels, each pixel may be converted to an RGB color. For example, based on the second image data, each pixel may be assigned a red color that corresponds to the intensity value for that pixel in the second image data; based on the third image data, each pixel may be assigned a green color that corresponds to the intensity value for that pixel in the third image data; and based on the fourth image data, each pixel may be assigned a blue color that corresponds to the intensity value for that pixel in the fourth image data. If no signal is detected for a pixel in a given channel, the pixel is assigned a value of 0 for the color that channel is mapped to (e.g., R or G). It is to be appreciated that the image data may be converted to RG or RGB regardless of the particular emission filters used in the imager. For example, the second channel may capture blue light, the third channel may capture red light, and the fourth channel may capture far-red light, but the image data may still be mapped to red and green (and optionally blue), which may increase human perceptual discernibility of the colors and provide a color range that spans the full gamut of human-perceptible colors. The conversion to RG or RGB may result in the multi-channel image data being represented with one RG or RGB color per pixel.

In this way, N fluorescent channels can be mapped to N perceptual channels. If N−1 fluorescent channels have the vast majority of signal, then the N−1 channels may be mapped to N−1 perceptual channels. For example, the two channels with best signal-to-noise ratio (SNR) may nominally be mapped to G and R respectively (or to R and G, respectively, though mapping to G and R may provide better perceptual sensitivity). Blue is not as perceptually sensitive, and thus if the SNR of the third channel is low, the image data in the third channel may be disregarded. However, if there is some signal in the third channel (e.g., the SNR of the third channel is sufficiently high), the third channel may be mapped to B. Also, more than three fluorescent channels could map to the three RGB channels as long as there are unique ratios among R, G, and B corresponding to unique colors (especially among the nine canonical colors). If variance in the ratios is sufficiently low, more than nine unique color tags could be represented in RGB or even in RG. However, the examples given have relatively high variance (low SNR) and so fewer colors can accurately be classified in RG (and B may not help because of the very low SNR of the third channel).

Performing the image processing may include, as indicated at 405, creating colored sub-images from the colored FOV image, using the bounding boxes that identify the location of each cell (e.g., as determined at 304 of method 300). In this way, a sub-image is created/extracted for each cell, that includes only the cell (and limited background) with the nucleus of the cell centered in the sub-image and the cell depicted in color based on the RG or RGB conversion. Each pixel of each sub-image may have a color represented by a red value, a green value, and optionally a blue value (when using RGB), each on a scale of 0-255, for example.

In some examples, performing the image processing may include performing brightness thresholding and/or saturation elimination, as indicated at 406. Performing brightness thresholding may include, for each sub-image, removing any pixels having a brightness below a threshold from further analysis, which may reduce background noise. The brightness threshold may be based on an analysis of class counts after class separation is performed, as will be described in more detail below. In other examples, the brightness threshold may be based on segmentation applied to classify foreground and background. For example, a Watershed or deep learning algorithm may be applied to classify foreground and background and the brightness threshold may be based on the brightness of the background pixels, for example (e.g., the average brightness of the background pixels, or maximum brightness of the background pixels). In still other examples, the brightness threshold may be based on brightness histogram percentiles for bimodal histograms. For cases where the foreground and background are sufficiently distinct in brightness, histograms typically are bimodal (meaning they have two local peaks): 1) low background mode and 2) high foreground mode. Such bimodal histograms can be separated into two Gaussian histograms and then benchmarks such as accuracy can be estimated and optimized by the false positives and false negatives vs. true positives given the two distributions and the threshold.

Performing the saturation elimination may include, for each sub-image, applying a respective saturation mask to remove pixels that exhibit saturation. The saturation mask may include a value (e.g., 0) for each pixel that has a maximum intensity in any of the channels and a different value (e.g., 1) for the remaining pixels, such that pixels that do not reach saturation are included while pixels that are saturated in at least one channel are excluded. It is to be appreciated that the brightness thresholding and saturation elimination may be performed on the colored FOV image, prior to extraction/creation of the sub-images.

At 408, method 400 includes converting the sub-images to perceptual color space. Converting the sub-images to perceptual color space may result in each sub-image being represented in perceptual color, wherein the perceptual color is based on the RG or RGB values for the pixels of the sub-image. Converting the sub-images to perceptual color space may include determining an average (e.g., mean) RG or RGB value for each sub-image and converting the mean RG or RGB value to a perceptual color value, such that each sub-image is represented by a single perceptual color. To determine the mean RG or RGB value for each sub-image, the non-black RG or RGB pixels (e.g., pixels with signal in at least one channel) are averaged within each sub-image to obtain an overall RG or RGB value for each sub-image.

As indicated at 410, converting the sub-images to perceptual color space may include converting each sub-image to hue using a hue-saturation-value (HSV) model. For example, for a given sub-image, the average RG or RGB value may be mapped to a hue value using an HSV model or an HSL model. For example, for each sub-image, the average RG value or average RGB value may be converted to an RGB light value and the RGB light value may be converted to hue. The RGB values of the sub-images may be standard RGB values (sRGB) optimized for display, and the RGB light values may be in linear color space that facilitates processing. To convert to RGB light values, two functions may be applied based on normalized sRGB values and a point where the two functions intersect. For example, the sRGB values (each of the R, G, and B values) may be normalized to a scale of 0-1 (e.g., by dividing by 255). For normalized values below the intersection point (e.g., 0.04045), the values may be divided by 12.92, while for normalized values above the intersection point, the values may be processed according to the equation (sRGB+0.055)/1.055)\hat{ }2.4.

The light RGB values are then converted to hue. In an example, to convert a selected sub-image to hue, the maximum value (Cmax) and the minimum value (Cmin) of the light RBG value is identified (e.g., the maximum and the minimum of the R, the G, and the B values for the selected sub-image) and a conditional equation applied based on the maximum value. The conditional equations may include:

If Cmax is R: Hue=(60*((G−B)/(Cmax−Cmin))+360)/360.

If Cmax is G: Hue=(60*((B−R)/(Cmax−Cmin))+120)/360.

If Cmax is B: Hue=(60*((R−G)/(Cmax−Cmin))+240)/360.

In some examples, particularly where the cells are imaged in three channels, the sub-images may be converted to hue and saturation of the HSV model.

Hue or hue-saturation is one way in which the sub-images may be represented in perceptual color space. However, other options are possible, such as converting using chromaticity, as indicated at 412. For example, each colored sub-image may be converted to perceptual color space using CIE1931 xyY or CIE 1976 (CIELAB and CIELUV). Converting RGB values to CIE1931 xyY color space may include the following. First, the mean RGB values are normalized to a range of [0,1] and gamma correction is applied (e.g., to produce the light RGB values discussed above). The normalized RGB values are then transformed into CIE XYZ tristimulus values using a linear transformation matrix that accounts for standard RGB primaries. Specifically, the X value is calculated as 0.4124564R+0.3575761G+0.1804375B, the Y value as 0.2126729R+0.7151522G+0.0721750B, and the Z value as 0.0193339R+0.1191920G+0.9503041B, where R, G, and B are the normalized RGB values. The XYZ values are then converted to xyY coordinates, where x=X/(X+Y+Z), y=Y/(X+Y+Z), and Y represents the luminance. The x and y coordinates specify the chromaticity of the color independent of luminance. To avoid division by zero when X+Y+Z equals zero, the color is set to black (0, 0, 0). The system also checks for and handles cases where the calculated chromaticity coordinates exceed the physical limits of visible wavelengths (x, y>0.6). For visualization purposes, the xyY values can be converted back to RGB/BGR color space through an inverse transformation process that includes saturation adjustment to enhance color differentiation.

At 414, statistical analysis is performed to identify thresholds that divide the sub-images into classes based on their perceptual colors. As indicated at 416, the statistical analysis may optionally include aggregating the color data via means or histograms. The color data (e.g., the perceptual color) may be aggregated in that the color data (e.g., perceptual color) may be considered for all sub-images. When aggregating via means, the approach may vary depending on whether ground truth data is available. In cases where ground truth data exists (e.g., hand annotated data, annotations by other fluorescent markers, or annotations by phenotypic/morphological class), the mean RG or RGB values of the ground truth data may be calculated per tag class and then converted to hue values. When aggregating via histograms (e.g., the hue values of the sub-images binned into a histogram), the method may include analyzing whether the histogram exhibits multi-modal characteristics. If the histogram is multi-modal with sufficient separation between modes, either Gaussian separation estimation may be performed to determine means of each Gaussian distribution, or local maxima within the histogram may be identified to correspond to different classes. When using Gaussian separation, thresholds may be set as averages between the means of adjacent Gaussian distributions. The selection between means-based or histogram-based approaches may depend on both the availability of ground truth data and the modal nature of the resulting histograms. Further, if k-means clustering is performed to separate the classes, aggregating via means or histograms may not be performed.

The statistical analysis may further include performing class separation on the aggregated color data, as indicated at 418. The class separation may include performing k-means clustering to find k class count clusters, identifying the k highest peaks of the histogram, performing manual class reference selection for cosine similarity classification, or performing percentile division of color mean value.

For example, k-means clustering may be performed on the hue values of the sub-images. The k-means clustering may partition the hue values into four classes (assuming four fluorophores) by assigning hue values to the nearest cluster by distance (e.g., squared Euclidean distance), which may be iteratively performed until convergence. In other examples, the hue values may be binned into a histogram as described above, and the three or four highest histogram peaks may be identified. The hue values in the bins of the highest peaks may be representative of each class. For well separated classes in a histogram, each mode (local maxima) corresponds to a class. Gaussian separation algorithms can be used for this, or simply finding local maxima within the histogram can be used. The better the separation, the more just the local maxima can be used.

In examples where class separation is performed using histogram analysis, the method may employ different approaches depending on the degree of separation between classes in the histogram. For well-separated classes, each mode (local maximum) in the histogram may correspond to a distinct class. The method may utilize Gaussian separation algorithms to identify and characterize these modes, or alternatively, may simply identify local maxima within the histogram when the separation between classes is particularly distinct. In cases where ground truth indicates that equal counts of each tag should be present, the thresholds may be set to minimize tag count variance across the classes. The specific approach selected may be based on the degree of separation between modes in the histogram and the quality of available ground truth data.

In some examples, k-means clustering may be performed to partition the hue values into three classes and a fourth “empty” class may be identified based on the brightness of each sub-image. The k-means clustering into three classes and an empty class may be performed when the signal from one fluorophore is completely (or nearly completely) blocked by the emission filters of the imager, and thus is not imaged in any of the channels. Accordingly, when k-means clustering is performed to separate the classes, brightness detection may be performed to identify the empty class, as indicated 419. The brightness detection may include determining the relative area of each sub-image that has a brightness above a threshold, and comparing the relative area to a threshold area (below which would be considered the empty class). Because the empty class is comprised of cells that incorporated a fluorophore that is not imaged in the channels, the overall brightness of the sub-images of the empty class may be lower than the sub-images of the cells of the other classes.

Thus, the statistical analysis performed to identify class separation thresholds may include various techniques such as k-means clustering, Gaussian mixture modeling, or histogram-based threshold determination. In k-means clustering, the representative perceptual hues are grouped into k clusters (where k is the number of expected classes) by iteratively assigning each hue value to the nearest cluster center and updating the cluster centers. In Gaussian mixture modeling, the distribution of hue values is modeled as a mixture of Gaussian distributions, with the intersections between these distributions serving as the class separation thresholds. For histogram-based analysis, the hue values are binned into a histogram and local minima between peaks are identified as class separation thresholds. The choice of statistical analysis technique may depend on factors such as the expected distribution of hue values and the presence of ground truth data for validation.

At 420, tag separation thresholds are identified from the statistical analysis. For example, when ground truth data is available, the thresholds may be based on the hue values of the mean RGB values for each known class. As another example, when clustering is performed, thresholds may be defined that define the boundaries between the clusters. The clustering may be one-dimensional (when only hue is considered) or multi-dimensional (when hue and saturation are considered or when hue and brightness/area are considered) and the thresholds may thus include only hue values, hue values and saturation values, or hue values and an area threshold. The clustering may be optimized for maximum class color divergence or minimum class count variance. For example, as explained above, a threshold area of brightness may be identified where below the threshold area, the sub-image is considered to belong to the empty class. The threshold area may be iteratively updated based on overall class counts after the clustering until the class counts are within a threshold range of each other.

In some examples, method 400 may include auditing the class separation. The auditing may include visually presenting class separation information to a user, so that the user can determine the accuracy of the class separation. The class separation information may include a histogram of hue values grouped by class or a FOV image that includes all the cells, with a visual indication of each class that each cell is assigned, such as a colored bounding box placed over each cell. The color of the bounding box may be based on the class that the cell's sub-image was classified into.

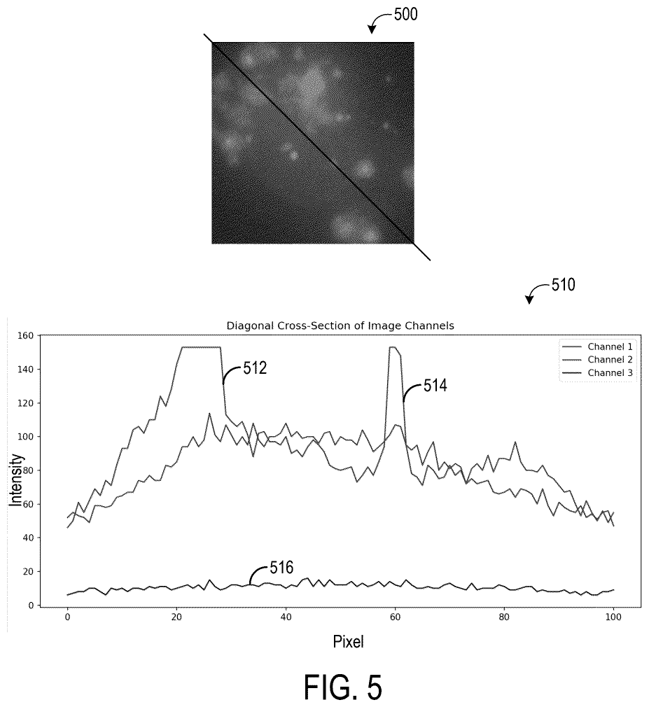

FIG. 5 shows an example sub-image 500 where the pixels of the sub-image are colored with RGB, as explained above. FIG. 5 further includes a plot 510 of intensity of the image data used to generate the sub-image 500 for the pixels sampled along the diagonal line placed over the sub-image 500. The plot 510 includes intensity values for each sampled pixel, for each of three channels. A first curve 512 depicts intensity as a function of pixel number for a first channel, a second curve 514 depicts intensity as a function of pixel number for a second channel, and a third curve 516 depicts intensity as a function of pixel number for a third channel.

As appreciated from the plot 510, the majority of the image information/signal intensity is captured in the first channel and the second channel. Thus, to color the sub-image 500, the intensity values for the first channel may be mapped to red, the intensity values for the second channel may be mapped to green, and the intensity values for the third channel may be mapped to blue. Mapping the channels with the strongest signals to red and green (as opposed to blue) may improve the human perceptibility of the colored sub-image.

Plot 510 further shows pixel clipping due to saturation of detector pixels in the first channel. For example, the detector may have a maximum detection limit of 150 intensity units. The signal in the first channel may exceed the maximum detection limit at two groups of pixels (e.g., pixels 21-28 and pixels 58-60), causing plateaus in the signal. Because the sub-image 500 is mapped to color based on the intensity value in each channel, the mapping to red may be inaccurate for the two groups of pixels, as the detected intensity values do not reflect the actual intensity of light emitted. The pixel clipping can cause color shifts. Hence, saturated pixels are filtered out via a saturation mask, as explained above.

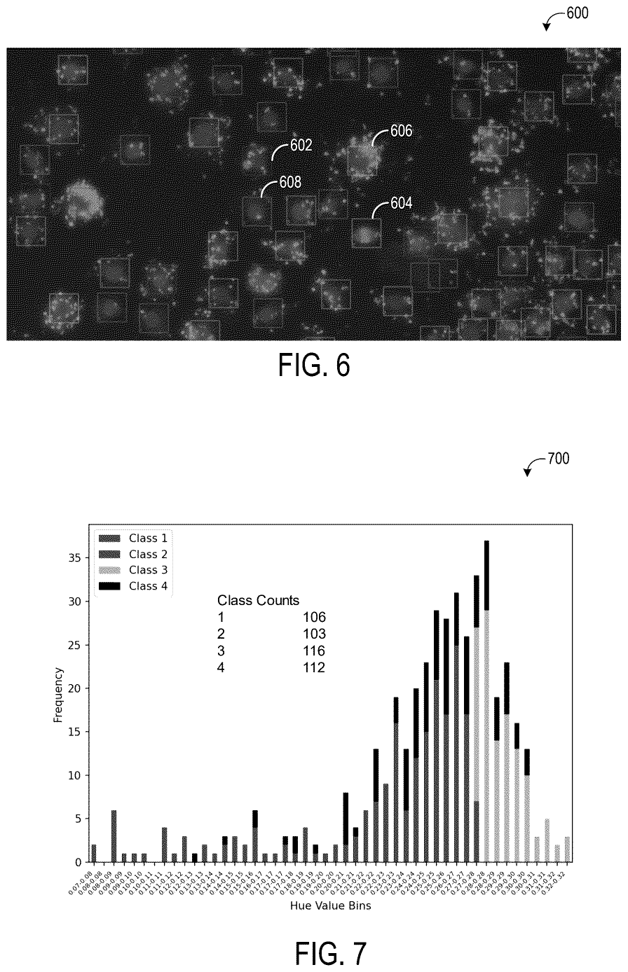

FIGS. 6 and 7 show example output that may be generated to audit class separation performed as part of a process to decode optical tags, such as at 422 of method 400. FIG. 6 shows a FOV image 600 of a sample including a plurality of cells that have undergone a round of tagging with a plurality of fluorophores, such as four types of fluorophores each coupled to a respective nucleotide. The FOV image may be colored in RGB as explained above with respect to FIG. 4 and the decoding process described above with respect to FIG. 4 performed to assign each cell to a class (e.g., corresponding to the type of fluorophore incorporated by that cell).

The FOV image 600 includes a plurality of bounding boxes, such as first bounding box 602, second bounding box 604, third bounding box 606, and fourth bounding box 608. Each bounding box identifies and demarcates a cell and is positioned such that the cell nucleus is centered within the bounding box. Each bounding box is colored based on the class that the cell identified by the bounding box has been assigned to. In the example shown in FIG. 6, the first bounding box 602 is colored red to indicate that the cell within the first bounding box 602 has been assigned to a first class. The second bounding box 604 is colored yellow to indicate that the cell within the second bounding box 604 has been assigned to a second class. The third bounding box 606 is colored green to indicate that the cell within the third bounding box 606 has been assigned to a third class. The fourth bounding box 608 is colored blue to indicate that the cell within the fourth bounding box 608 has been assigned to a fourth class. In this way, a user can view the FOV image 600 and determine if the class assignment for each cell matches the user's perception of which class each cell should be assigned to, based on the colors of the spots exhibited by each cell. It is to be appreciated that in the example shown in FIG. 6, the fourth class may be an “empty” class whereby the fluorophore incorporated by the cells of the empty class is not visible to the imager (e.g., due to the emission spectrum of the fluorophore and emission filters of the imager).

FIG. 7 shows a histogram 700 of hue values for a plurality of cells/sub-images of a FOV image (e.g., FOV image 600) that has undergone the decoding process of method 400. The hue values are assigned to each sub-image as described above and then binned into the histogram. The histogram bins are colored based on class assignment, such that sub-images classified into a first class are colored in red, sub-images classified into a second class are colored in green, sub-images classified into a third class are colored in cyan, and sub-images classified into a fourth class are colored in black. The classification into the first class, the second class, and the third class may be based on hue value relative to one or more thresholds, as explained above with respect to FIG. 4. The classification into the fourth class may be based on brightness/area relative to a threshold.

From the histogram 700, it can be appreciated that a first threshold separating the first class from the second class may be a hue value of 0.24 and a second threshold separating the second class from the third class may be a hue value of 0.28. Further, the fourth class may include cells with hue values that are initially classified into each of the other three classes and then moved to the fourth class based on the cells exhibiting a relatively low brightness.

Further, the number of sub-images/cells classified into each class may be counted and listed as class counts. In the example shown in FIG. 7, the class counts may include 106 cells assigned to the first class, 103 cells assigned to the second class, 116 cells assigned to the third class, and 112 cells assigned to the fourth class. In examples where the thresholds are set to minimize class count variance, the relatively large difference in the number of cells classified into the second class and third class, for example, may prompt iterative optimization of the thresholds (including the threshold separating the first class from the second class, the threshold separating the second class from the third class, and the brightness/area threshold dictating which cells are classified into the fourth class).

In summary, the systems and methods for decoding fluorescent tags in multi-channel image data disclosed herein overcome the issues associated with traditional unmixing approaches. Rather than relying on matrix operations that may fail due to unknown fluorophore emission ratios across channels, the disclosed methods convert multi-channel image data to a perceptual color space and classify cells based on their representative perceptual hue values. The methods include extracting sub-images of individual cells, converting the pixel data to RG or RGB color space, applying preprocessing steps such as brightness thresholding and saturation correction, and determining a representative perceptual hue for each cell. The cells are then classified into different groups using various classification approaches, such as k-means clustering, histogram peak analysis, or threshold-based classification using mean values. This approach provides more robust and reliable tag classification compared to traditional unmixing methods, while also generating results that are intuitive for visual inspection and manual auditing. The methods are particularly valuable for applications such as optical pooled screens where accurate barcode reading across multiple rounds of imaging is demanded.

A technical effect of determining a representative perceptual hue for each of a plurality of multi-channel sub-images of tagged cells and classifying the sub-images into groups based on the representative perceptual hues is that the tags incorporated into the cells may be identified/classified in a robust and reliable manner and that allows for visual inspection.

The disclosure also provides support for a method, comprising: obtaining multi-channel image data of a sample including a plurality of cells, converting the multi-channel image data to a colored field of view (FOV) image using a red-green (RG) or red-green-blue (RGB) model based on the multi-channel image data, such that the colored FOV image comprises a plurality of colored pixels, extracting, for each cell of the plurality of cells and from the colored FOV image, a respective sub-image including that cell, each respective sub-image comprising a respective subset of colored pixels, identifying a representative perceptual hue for each respective sub-image based on that sub-image's subset of colored pixels, and classifying the plurality of cells into two or more classes based on the representative perceptual hue for each respective sub-image. In a first example of the method, identifying the representative perceptual hue for each respective sub-image based that sub-image's subset of colored pixels comprises, for a first sub-image, determining an average RG color or an average RGB color and mapping the average RG color or the average RGB color to a first perceptual hue. In a second example of the method, optionally including the first example, the mapping is based on a hue-saturation-value model. In a third example of the method, optionally including one or both of the first and second examples, the method further comprises: applying a brightness threshold to the colored FOV image or to each respective sub-image such that only pixels with a brightness above the brightness threshold are considered when identifying the representative perceptual hue for each respective sub-image. In a fourth example of the method, optionally including one or more or each of the first through third examples, the method further comprises: applying a respective saturation mask to each respective sub-image to remove pixels that are saturated in any channel. In a fifth example of the method, optionally including one or more or each of the first through fourth examples, classifying the plurality of cells into two or more classes based on the representative perceptual hue for each respective colored sub-image comprises performing clustering on all of the representative perceptual hues of the sub-images. In a sixth example of the method, optionally including one or more or each of the first through fifth examples, the method further comprises: outputting results of the classification for display on a display device and/or for storage in memory. In a seventh example of the method, optionally including one or more or each of the first through sixth examples, outputting the results of the classification comprises outputting, for display on the display device, the colored FOV image including a plurality of colored bounding boxes, each colored bounding box identifying a respective cell of the plurality of cells and having a color that identifies a class of the two or more classes to which that cell was assigned by the classification. In a eighth example of the method, optionally including one or more or each of the first through seventh examples, the sample has undergone a round of tagging with two or more types of fluorophores, such that each cell of the plurality of cells has incorporated at least one of the two or more types of fluorophores, and wherein each class of the two or more classes corresponds to a respective one of the two or more types of fluorophores. In a ninth example of the method, optionally including one or more or each of the first through eighth examples, each type of fluorophore is associated with a respective nucleotide of a plurality of nucleotides and wherein outputting the results of the classification for storage in memory includes building a barcode annotation for each cell by assigning each cell of the plurality of cells a respective nucleotide of the plurality of nucleotides based on a class of the two or more classes to which that cell was assigned by the classification.

The disclosure also provides support for a system, comprising memory storing instructions, one or more processors configured to execute the instructions to: obtain multi-channel image data of a sample including a plurality of cells, wherein the sample has undergone a round of tagging with two or more types of fluorophores, such that each cell of the plurality of cells has incorporated at least one of the two or more types of fluorophores, convert the multi-channel image data to a colored field of view (FOV) image using a red-green (RG) or red-green-blue (RGB) model based on the multi-channel image data, such that the colored FOV image comprises a plurality of colored pixels, extract, for each cell of the plurality of cells and from the colored FOV image, a respective sub-image including that cell, each respective sub-image comprising a respective subset of colored pixels, identify a representative perceptual hue for each respective sub-image based on that sub-image's subset of colored pixels, classify the plurality of cells into two or more classes based on the representative perceptual hue for each respective sub-image, each class of the two or more classes corresponding to a respective one of the two or more types of fluorophores, and output results of the classification for display on a display device and/or for storage in memory. In a first example of the system, each type of fluorophore is associated with a respective nucleotide of a plurality of nucleotides and wherein outputting the results of the classification for storage in memory includes building a barcode annotation for each cell by assigning each cell of the plurality of cells a respective nucleotide of the plurality of nucleotides based on a class of the two or more classes to which that cell was assigned by the classification. In a second example of the system, optionally including the first example, outputting the results of the classification comprises outputting, for display on the display device, the colored FOV image including a plurality of colored bounding boxes, each colored bounding box identifying a respective cell of the plurality of cells and having a color that identifies a class of the two or more classes to which that cell was assigned by the classification. In a third example of the system, optionally including one or both of the first and second examples, identifying the representative perceptual hue for each respective sub-image based that sub-image's subset of colored pixels comprises, for a first sub-image, determining an average RG color or an average RGB color and mapping the average RG color or the average RGB color to a first perceptual hue, wherein the mapping is based on a hue-saturation-value model or chromaticity. In a fourth example of the system, optionally including one or more or each of the first through third examples, the instructions are further executable by the one or more processors to apply a brightness threshold and/or a saturation mask to the colored FOV image or to each respective sub-image such that only pixels with a brightness above the brightness threshold and/or pixels that are not saturated in any channel are considered when identifying the representative perceptual hue for each respective sub-image. In a fifth example of the system, optionally including one or more or each of the first through fourth examples, classifying the plurality of cells into two or more classes based on the representative perceptual hue for each respective colored sub-image comprises performing a statistical analysis on all of the representative perceptual hues of the sub-images to identify one or more class separation thresholds. In a sixth example of the system, optionally including one or more or each of the first through fifth examples, performing the statistical analysis comprises performing k-means clustering on all of the representative perceptual hues of the sub-images or binning all of the representative perceptual hues of the sub-images into a histogram.

The disclosure also provides support for a system, comprising: memory storing instructions, one or more processors configured to execute the instructions to: obtain multi-channel image data of a sample including a plurality of cells, wherein the sample has undergone a round of tagging with two or more types of fluorophores, such that each cell of the plurality of cells has incorporated at least one of the two or more types of fluorophores, each type of fluorophore associated with a respective nucleotide of a plurality of nucleotides, convert the multi-channel image data to a colored field of view (FOV) image using a red-green (RG) or red-green-blue (RGB) model based on the multi-channel image data, such that the colored FOV image comprises a plurality of colored pixels, extract, for each cell of the plurality of cells and from the colored FOV image, a respective sub-image including that cell, each respective sub-image comprising a respective subset of colored pixels, identify a representative perceptual hue for each cell of the plurality of cells based on a respective subset of the plurality of colored pixels corresponding to each cell, classify the plurality of cells into two or more classes based on the representative perceptual hue for each cell, each class of the two or more classes corresponding to a respective one of the two or more types of fluorophores, build a barcode annotation for each cell by assigning each cell of the plurality of cells a respective nucleotide of the plurality of nucleotides based on a class of the two or more classes to which that cell was assigned by the classification, and output the barcode annotation for each cell for display on a display device and/or for storage in memory. In a first example of the system, classifying the plurality of cells into two or more classes based on the representative perceptual hue for each cell comprises performing a statistical analysis on all of the representative perceptual hues of the plurality of cells to identify one or more class separation thresholds. In a second example of the system, optionally including the first example, performing the statistical analysis comprises performing k-means clustering on all of the representative perceptual hues of the plurality of cells or binning all of the representative perceptual hues of the plurality of cells into a histogram.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method, comprising:
obtaining multi-channel image data of a sample including a plurality of cells;
converting the multi-channel image data to a colored field of view (FOV) image using a red-green (RG) or red-green-blue (RGB) model based on the multi-channel image data, such that the colored FOV image comprises a plurality of colored pixels;
extracting, for each cell of the plurality of cells and from the colored FOV image, a respective sub-image including that cell, each respective sub-image comprising a respective subset of colored pixels;
identifying a representative perceptual hue for each respective sub-image based on that sub-image's subset of colored pixels; and
classifying the plurality of cells into two or more classes based on the representative perceptual hue for each respective sub-image.

2. The method of claim 1, wherein identifying the representative perceptual hue for each respective sub-image based that sub-image's subset of colored pixels comprises, for a first sub-image, determining an average RG color or an average RGB color and mapping the average RG color or the average RGB color to a first perceptual hue.

3. The method of claim 2, wherein the mapping is based on a hue-saturation-value model.

4. The method of claim 1, further comprising, applying a brightness threshold to the colored FOV image or to each respective sub-image such that only pixels with a brightness above the brightness threshold are considered when identifying the representative perceptual hue for each respective sub-image.

5. The method of claim 1, further comprising applying a respective saturation mask to each respective sub-image to remove pixels that are saturated in any channel.

6. The method of claim 1, wherein classifying the plurality of cells into two or more classes based on the representative perceptual hue for each respective colored sub-image comprises performing clustering on all of the representative perceptual hues of the sub-images.

7. The method of claim 1, further comprising outputting results of the classification for display on a display device and/or for storage in memory.

8. The method of claim 7, wherein outputting the results of the classification comprises outputting, for display on the display device, the colored FOV image including a plurality of colored bounding boxes, each colored bounding box identifying a respective cell of the plurality of cells and having a color that identifies a class of the two or more classes to which that cell was assigned by the classification.

9. The method of claim 7, wherein the sample has undergone a round of tagging with two or more types of fluorophores, such that each cell of the plurality of cells has incorporated at least one of the two or more types of fluorophores, and wherein each class of the two or more classes corresponds to a respective one of the two or more types of fluorophores.

10. The method of claim 9, wherein each type of fluorophore is associated with a respective nucleotide of a plurality of nucleotides and wherein outputting the results of the classification for storage in memory includes building a barcode annotation for each cell by assigning each cell of the plurality of cells a respective nucleotide of the plurality of nucleotides based on a class of the two or more classes to which that cell was assigned by the classification.

11. A system, comprising
memory storing instructions;
one or more processors configured to execute the instructions to:
obtain multi-channel image data of a sample including a plurality of cells, wherein the sample has undergone a round of tagging with two or more types of fluorophores, such that each cell of the plurality of cells has incorporated at least one of the two or more types of fluorophores;
convert the multi-channel image data to a colored field of view (FOV) image using a red-green (RG) or red-green-blue (RGB) model based on the multi-channel image data, such that the colored FOV image comprises a plurality of colored pixels;
extract, for each cell of the plurality of cells and from the colored FOV image, a respective sub-image including that cell, each respective sub-image comprising a respective subset of colored pixels;
identify a representative perceptual hue for each respective sub-image based on that sub-image's subset of colored pixels;
classify the plurality of cells into two or more classes based on the representative perceptual hue for each respective sub-image, each class of the two or more classes corresponding to a respective one of the two or more types of fluorophores; and
output results of the classification for display on a display device and/or for storage in memory.

12. The system of claim 11, wherein each type of fluorophore is associated with a respective nucleotide of a plurality of nucleotides and wherein outputting the results of the classification for storage in memory includes building a barcode annotation for each cell by assigning each cell of the plurality of cells a respective nucleotide of the plurality of nucleotides based on a class of the two or more classes to which that cell was assigned by the classification.

13. The system of claim 11, wherein outputting the results of the classification comprises outputting, for display on the display device, the colored FOV image including a plurality of colored bounding boxes, each colored bounding box identifying a respective cell of the plurality of cells and having a color that identifies a class of the two or more classes to which that cell was assigned by the classification.

14. The system of claim 11, wherein identifying the representative perceptual hue for each respective sub-image based that sub-image's subset of colored pixels comprises, for a first sub-image, determining an average RG color or an average RGB color and mapping the average RG color or the average RGB color to a first perceptual hue, wherein the mapping is based on a hue-saturation-value model or chromaticity.

15. The system of claim 11, wherein the instructions are further executable by the one or more processors to apply a brightness threshold and/or a saturation mask to the colored FOV image or to each respective sub-image such that only pixels with a brightness above the brightness threshold and/or pixels that are not saturated in any channel are considered when identifying the representative perceptual hue for each respective sub-image.

16. The system of claim 11, wherein classifying the plurality of cells into two or more classes based on the representative perceptual hue for each respective colored sub-image comprises performing a statistical analysis on all of the representative perceptual hues of the sub-images to identify one or more class separation thresholds.

17. The system of claim 16, wherein performing the statistical analysis comprises performing k-means clustering on all of the representative perceptual hues of the sub-images or binning all of the representative perceptual hues of the sub-images into a histogram.

18. A system, comprising:
memory storing instructions;
one or more processors configured to execute the instructions to:
obtain multi-channel image data of a sample including a plurality of cells, wherein the sample has undergone a round of tagging with two or more types of fluorophores, such that each cell of the plurality of cells has incorporated at least one of the two or more types of fluorophores, each type of fluorophore associated with a respective nucleotide of a plurality of nucleotides;
convert the multi-channel image data to a colored field of view (FOV) image using a red-green (RG) or red-green-blue (RGB) model based on the multi-channel image data, such that the colored FOV image comprises a plurality of colored pixels;
extract, for each cell of the plurality of cells and from the colored FOV image, a respective sub-image including that cell, each respective sub-image comprising a respective subset of colored pixels;
identify a representative perceptual hue for each cell of the plurality of cells based on a respective subset of the plurality of colored pixels corresponding to each cell;
classify the plurality of cells into two or more classes based on the representative perceptual hue for each cell, each class of the two or more classes corresponding to a respective one of the two or more types of fluorophores;
build a barcode annotation for each cell by assigning each cell of the plurality of cells a respective nucleotide of the plurality of nucleotides based on a class of the two or more classes to which that cell was assigned by the classification; and
output the barcode annotation for each cell for display on a display device and/or for storage in memory.

19. The system of claim 18, wherein classifying the plurality of cells into two or more classes based on the representative perceptual hue for each cell comprises performing a statistical analysis on all of the representative perceptual hues of the plurality of cells to identify one or more class separation thresholds.

20. The system of claim 19, wherein performing the statistical analysis comprises performing k-means clustering on all of the representative perceptual hues of the plurality of cells or binning all of the representative perceptual hues of the plurality of cells into a histogram.
